(19) United States
(12) Patent Application Publication
(10) Pub. No.: US 2015/0254383 A1
(43) Pub. Date: Sep. 10, 2015

(54) METHOD FOR CONCURRENT SIMULATION TO EVALUATE THE TEST QUALITY OF INTEGRATED CIRCUITS AND COMPUTER PROGRAM

(71) Applicant: StarDFX Technologies, Inc., Sunnyvale, CA (US)

(72) Inventors: TSAI TSO-SHENG, SARATOGA (CA); WANG Laung-Terng, SUNNYVALE, CA (US); HYOUNG-KOOK KIM, CUPERTINO, CA (US)

(73) Assignee: StarDFX Technologies, Inc.

(21) Appl. No.: 14/615,949

(22) Filed: Feb. 6, 2015

Related U.S. Application Data
(60) Provisional application No. 61/936,425, filed on Feb. 6, 2014.

(51) Int. Cl. G06F 17/50

(52) U.S. Cl. CPC G06F 17/5022; G06F 17/5045

(57) ABSTRACT

A method to evaluate the quality of testbenches using concurrent simulation for functional verification or fault simulation of a digital circuit in an integrated circuit or a system is described. The digital circuit is modeled in a high-level hardware description language. Mutations can be thought of as artificial bugs or design faults which are described at a behavioral or system level. A computer first reads in the digital circuit. Mutations are then inserted into the circuit model that describes the digital circuit. Simulation of multiple mutations is finally performed concurrently to check whether each inserted mutation has generated an output value which is different from a reference value. The reference value may be generated internally from the digital circuit or testbenches, or generated externally from an independent reference system. The reference system may be a hardware accelerator or an identical design developed independent of the circuit model to meet the design's specifications. The concurrent simulation method also applies to software testing of computer programs.

### FIELD OF THE INVENTION

The present invention generally relates to the field of design, verification and test of integrated circuits and computer programs. Specifically, the present invention relates to the field of functional verification and fault simulation of digital integrated circuits as well as software testing of computer programs.

### BACKGROUND

Test techniques have been widely used to verify the correctness of integrated circuits and computer programs. Such test techniques are typically referred to as functional verification and fault simulation of integrated circuits or software testing of computer programs. These test techniques often rely on extensive simulations to detect errors or bugs embedded in the integrated circuits or computer programs. As traditional simulation methods can cause fairly slow simulation performance, ensuring the correctness of these integrated circuits or computer programs has become a very serious problem, particularly, when these integrated circuits or computer programs are to be used for safety-critical and mission-critical applications.

Functional verification is a verification technique that has been heavily used to verify the correctness of a digital circuit in an integrated circuit or in a system. Functional verification can be classified into dynamic verification and formal verification (Wang 2009). Dynamic verification is simulation-based which requires testbenches; while formal verification tries to prove if the design is correct by construction using formal approaches (such as equivalence checking, model checking, and theorem proving) without using testbenches. During the verification stage, design engineers or verification engineers may create testbenches and assertions first. Logic simulation or formal verification tools may then be performed to help verify whether the design meets its specifications, or contains any design errors. As functional verification could consume more than 70% of the design efforts (Wang 2009), to speed up its process a number of coverage metrics have been proposed to measure the effectiveness of these testbenches and assertions in detecting design errors.

Modern digital circuit designs are mostly described in high-level hardware description languages. System Verilog HDL, Verilog HDL and VHDL are three major hardware description languages widely adopted. A high-level hardware description language allows design engineers to describe a digital circuit as a mix of power lines, transistors, MOS switches, logic gates, register-transfer level (RTL) elements, and behavioral- and system-level functions. Other than the logic circuit, the description language can also include control and driving mechanisms (commonly known as “testbenches”) to perform simulations on the digital circuit itself. A complete simulation system should be able to handle all of the transistors, switches, logic gates, and RTL, behavioral-level, and system-level statements. As a result, logic simulation is fairly slow that can significantly affect the progress of functional verification.

Prior art coverage metrics can be broadly divided into 6 categories: Ad hoc metrics, structural coverage, functional coverage, assertion coverage, observability-based coverage, and mutation analysis. The author in (Bailey 2007) described the benefits and problems of these metrics in greater detail. An abstract is summarized below:

Ad hoc metrics include metrics such as bug discovery rates, bug densities and a number of other metrics that provide a general indication about the stability of the design. They provide no objective information about the quality of the design or the verification progress, but they have been a useful management indicator in the past and continue to be used today.

Structural coverage metrics calculate a coverage number based on specific structural representations, such as line, branch, and expression coverage, in the hardware description model. They are the most popular measures and most people consider structural coverage as code coverage, although this is just one example of structural coverage.

Functional coverage metrics, on the other hand, focus on the semantics or the design intent of the hardware description model. They measure the coverage of particular observable events that are an indicator of those functionalities having been executed. The list of coverage points is generally obtained from a specification or verification plan.

Assertion coverage can be part of an assertion-based verification in a dynamic verification environment or a formal verification. If we consider that an assertion defines a set of functionality that corresponds to some—hopefully equivalent—functionality in an implementation, then assertions are a form of checker and an integral part of the dynamic verification environment. Assertions are built out of properties, which are the fundamental cornerstone of formal verification. The issue is when a complete set of properties that cover all specified requirements can be defined so formal approaches (such as equivalence checking, model checking, and theorem proving) can be used to prove the correctness of the model (Wang 2009).

Observability-Based Coverage addresses the big drawback with both structural and functional metrics in that they are both isolated observations of events that provide no indication that the correct behavior is associated with those observations (Devadas 1996). It was the first advancement that was made in coverage to mimic the production test methodology and incorporate observability into the metric. As it still assumed that a suitable checker existed to identify an incorrect result, the correlation between the ability to propagate tags (additional assignments at the activation points) and the ability to propagate errors is not clear.

Mutation Analysis presents the second advancement coming from the software world. The injection of an error into software or a design as a method of determining verification effectiveness is known as mutation analysis (DeMillo 1978). Mutation analysis injects errors into either a hardware or software implementation. These errors are called mutants (a.k.a. mutations) and represent the simplest functional errors or design errors an engineer could make. Mutant operators are created to induce simple syntax changes based on these errors. The Mothra mutant operators given in (King 1991) and (Offutt 1996) represent an example of design errors. Mutation analysis is based on two hypotheses: first, that programmers or engineers write code that is close to being correct, and second, that a test that distinguishes the good version from all its mutants is also sensitive to more complex errors.

Mutation analysis draws on some of the good features of the older coverage metrics, such as structural coverage. The injection of an error model is performed automatically, so there is no user intervention required—unlike functional coverage and assertion coverage—and mutation coverage can be automated. Automation makes it quick, effective and objective. Mutation analysis also provides a definitive and objective measure of completeness since a complete analysis of the source will identify the totality of the faults that should be injected and we know what 100% means. Finally, because the mutants may introduce new functionality that was not present in the source, it may identify functionality that is missing, which removes one of the big limitations of structural coverage.

As mutation analysis has many benefits unmatched by using other coverage metrics, a commercial functional qualification system called Certitude based on mutation analysis for functional verification of digital circuits has been developed (Synopsys 2014). Certitude intends to qualify a verification environment based on both testcases (testbenches) and assertions (Bombieri 2009). Different from traditional mutation analysis which only measures the ability of the input sequences to propagate potential bugs (design errors) to (checker) outputs, Certitude only considers a mutation to have been killed only if a testcase fails in detecting potential bugs at outputs.

The Certitude functional qualification system automatically inserts mutations into an existing RTL code and determines if the verification environment can detect these mutations (mutations can be thought of as artificial bugs or faults). For example, a=b|C; (original code) is mutated into a=b & c; (faulty program code). Simulation of a mutated design is then performed, where only one of the mutations is ever active, while the other mutations are inactive, and where the mutations are activated in succession (see U.S. Pat. No. 8,311,793 by Grosse and Hampton). The system then determines whether the verification environment can activate the faulty code, propagate the effects to an observable point, and detect the present of the fault (Synopsys 2014).

Since Certitude can only perform simulation of mutations in a serial manner, the runtime overhead is a major concern when it is required to consider millions of mutations. As functional verification could consume more than 70% of the design efforts and time-to-market has become a critical issue in today's competitive environment, there is a crucial need for using a concurrent simulation method to speed up simulation of two or more mutations concurrently. Because mutations are artificial bugs or faults that appear at a behavioral level, the mutation-based technique for functional verification can be also used to speed up concurrent fault simulation at the behavioral level.

Regarding fault simulation, the major difference between logic simulation and fault simulation lies in the nature of the non-idealities they deal with. Logic simulation is intended for identifying design errors using the given specifications or a known good design as the reference. Design errors may be introduced by human designers or electronic design automation (EDA) tools, and should be caught prior to physical implementation. Fault simulation, on the other hand, is concerned with the behavior of fabricated circuits as a consequence of inevitable fabrication process imperfections. The manufacturing defects (e.g., wire shorts and opens), if present, may cause the circuits to behave differently from the expected behavior. Fault simulation generally assumes that the design is functionally correct.

Although fault simulation is rooted in logic simulation, many techniques have been developed to quickly simulate all possible faulty behaviors. The prior art techniques include serial, parallel, deductive, differential, and concurrent fault simulation (Wang 2006). All these techniques have their respective advantages and disadvantages. However, from performance (simulation efficiency) and memory management points of view, concurrent fault simulation based on event-driven (logic) simulation has become the dominant solution widely used in the semiconductor industry (Wang 2006).

The relationship between fault simulation and logic simulation can be illustrated with certain popular commercial simulators. For example, Verilog-XL and NC-Verilog (both from Cadence Design Systems), VCS (from Synopsys), and ModelSim (from Mentor Graphics), are typical event-driven simulators. As of today, these logic simulators can simulate a design described at the behavioral level. Commercial fault simulators, such as TurboFault (from SynTest Technologies), Z01X (from WinterLogic), and Verifault (from Cadence Design Systems), are based on concurrent fault simulation. However, these commercially-available concurrent fault simulators can only grade structural faults (such as stuck-at faults, delay faults, and bridging faults) at the gate level. Even if behavioral faults can be inserted in the design at the RTL or behavioral/system level, such as those given in (Ward 1990), prior art behavioral fault simulators are not based on concurrent fault simulation. Hence, there is also a need for developing a concurrent fault simulator that can also grade faults (mutations) concurrently at the RTL or behavioral/system level. As the correctness of computer programs has been long evaluated using mutation analysis, there is a further need for developing a concurrent simulator to speed up the simulation process for software testing of computer programs.

### SUMMARY OF THE INVENTION

The present invention encompasses any concurrent simulation methods that can be used to speed up the simulation process of integrated circuits or systems as well as computer programs based on mutation analysis. Specifically, the concurrent simulation method may be used for functional verification or fault simulation of integrated circuits or systems. It may be further used for software testing of computer programs.

In the present invention, mutations can be thought of artificial bugs or design faults that will be inserted (or instrumented) into a computer program or an integrated circuit or system for concurrent simulation. An artificial bug may be a coding error in a computer program. A design fault may comprise one or more structural faults and behavioral faults in an integrated circuit or system. A structural fault may be a stuck-at fault, a delay fault, a bridging fault, an open fault, or an IDD quiescent (IDDM) fault. A behavioral fault may comprise a Stuck-Then fault, a Stuck-Else fault, an Assignment Control fault, a Dead Process fault, a Dead Clause fault, a Micro-operation fault, a Local Stuck-data fault, or a Global Stuck-data fault, as given in (Ward 1990). The behavioral faults may further comprise other system-level faults, such as module faults. Multiple structural faults and behavioral faults may exist at the same time.

A typical design in an integrated circuit or system may contain a circuit model which comprises a plurality of logic gates, switches, RTL elements, high-level statements and tasks. The circuit model may be described in a gate-level format, a register-transfer-level (RTL) format, or a behavioral-level/system-level model. Assume the design is to be verified or tested by one or more functional patterns that may be modeled at a behavioral or system level, termed as testbenches. Both circuit model and testbenches may be modeled in a hardware description language, such as System Verilog HDL (an IEEE Std. 1800), Verilog HDL (an IEEE Std. 1364) or VHDL (an IEEE Std. 1076).

In a first embodiment of the present invention, the circuit model and testbenches are translated altogether into a design database. Not only is the circuit model translated, the testbenches and behavioral-/system-level statements are also translated. The design translator may directly generate C/C++ language codes or assembly codes for each design element. This will increase the computation efficiency for the design elements. It can also handle a design which has various parts implemented in different high-level hardware description languages. For instance, one part of the design may be implemented with the Verilog HDL languages when the rest of the design is coded with the VHDL language. Any design changes may be also re-synthesized incrementally to save time. All design signal names, structures, hierarchy information, etc., are stored in the design database.

In a second embodiment of the present invention, structural faults and behavioral faults may be generated automatically or inserted manually in an integrated circuit or system. A structural fault may be a stuck-at fault, a delay fault, a bridging fault, an open fault, or an IDD quiescent (IDDM) fault which may be assigned to an input, an output, or an internal wire/net or node. A behavioral fault is an artificial bug or a mutation which is inserted into register-transfer-level (RTL) code or behavioral-/system-level code. It may comprise a Stuck-Then fault, a Stuck-Else fault, an Assignment Control fault, a Dead Process fault, a Dead Clause fault, a Micro-operation fault, a Local Stuck-data fault, or a Global Stuck-data fault. It may further comprise a module fault which may contain one or more other types of design faults.

In a third embodiment of the present invention, N design faults (N mutations) are automatically inserted (or instrumented) into the design database, where N may be a user-predetermined number or a scalable number chosen by a computer considering the memory capacity and efficiency of the computer, N>=2. A concurrent simulation is then performed on the design database to simulate the N mutated circuits concurrently. A fault is considered detected and may be dropped from further simulation immediately at the time when the fault has produced an output value which is different from a reference value. The reference value may be generated internally from the circuit model or testbenches, or generated externally from an independent reference system. The reference system may be a hardware accelerator or an identical design developed independently to meet the design's specifications. Once the first set of N design faults is processed, a next set of N design faults is processed. This process continues until all design faults have been processed or is terminated when a certain predetermined criterion is reached.

Since a fault only affects the logic in the fanout cone from the fault site, the original circuit and mutated (faulty) circuits typically only differ in a small region. Concurrent functional qualification or concurrent fault simulation exploits this fact and simulates only the differential parts of the whole circuit. Concurrent simulation (which is used to generally refer to as a concurrent functional qualification or a concurrent fault simulation hereunder) is essentially a logic simulation with the original circuit and mutated (faulty) circuits simulated altogether in a concurrent manner. Compared to serial simulation which performs a logic simulation on one mutated circuit at a time, concurrent simulation often can achieve a speedup in one to two orders of magnitude. As a result, it becomes possible to simulate millions of mutations for a large integrated circuit or system.

In concurrent simulation, every design element has a concurrent fault list, which consists of a set of mutated elements. A mutated element of design element e represents an imaginary copy of element e in the presence of a fault. Every mutated element contains a fault index and the associated element I/O values in the presence of the corresponding fault. Initially, the concurrent fault list of element e contains local faults of element e. The local faults of element e may comprise faults on the inputs or outputs of element e. As the simulation proceeds, the concurrent fault list contains not only local faults but also faults propagated from previous stages. Local faults of element e remain in the concurrent fault list of element e until they are detected.

### THE BRIEF DESCRIPTION OF DRAWINGS

FIG. 1 shows a diagram of a concurrent simulation system, in accordance with the present invention;

FIGS. 2A and 2B show Stuck-Then faults at a behavioral level, in accordance with the present invention;

FIGS. 3A and 3B show Stuck-Else faults at a behavioral level, in accordance with the present invention;

FIGS. 4A, 4B, and 4C are Assignment Control faults at a behavioral level, in accordance with the present invention;

FIGS. 5A and 5B show Dead Process faults at a behavioral level, in accordance with the present invention;

FIGS. 6A and 6B show Dead Clause faults at a behavioral level, in accordance with the present invention;

FIGS. 7A and 7B show Micro-operation faults at a behavioral level, in accordance with the present invention;

FIGS. 8A and 7B show Local Stuck-data faults at a behavioral level, in accordance with the present invention;

FIGS. 9A and 9B show Global Stuck-data faults at a behavioral level, in accordance with the present invention; and

FIGS. 10A and 10B show module faults at a behavioral level, in accordance with the present invention.

### DETAILED DESCRIPTION OF THE INVENTION

The following description is presently contemplated as the best mode of carrying out the present invention. This description is not to be taken in a limiting sense but is made merely for the purpose of describing the principles of the invention. The scope of the invention should be determined by referring to the appended claims.

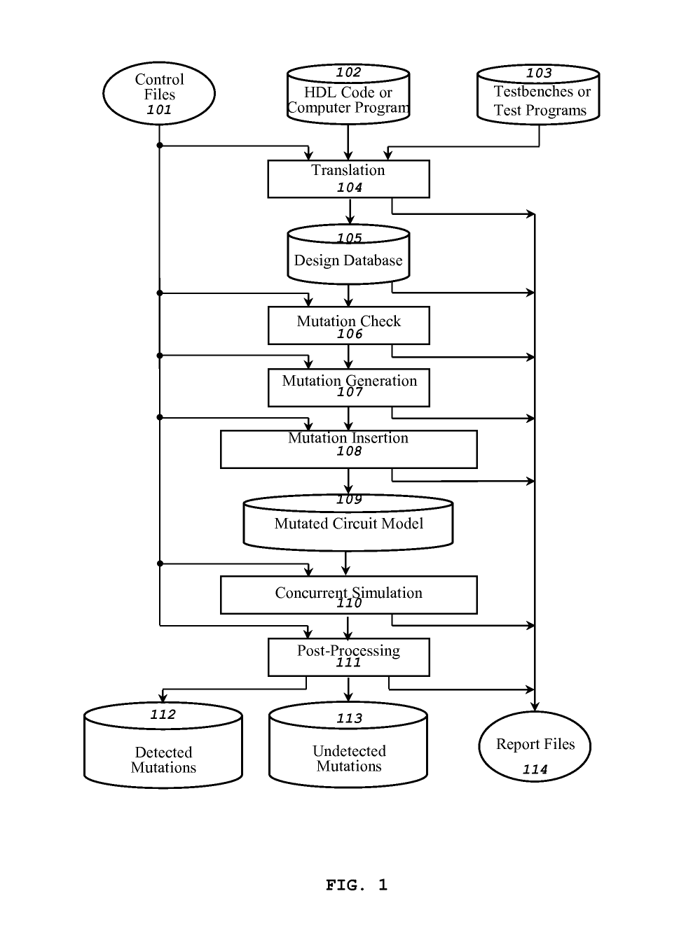

FIG. 1 shows a diagram of a concurrent simulation system, in accordance with the present invention. The concurrent simulation system 100 may comprise accepting a user-supplied HDL Code or Computer Program 102 together with Control Files 101 and the Testbenches or Test Programs 103. The Control Files 101 may contain all set-up information and scripts required for Translation 104, optional Mutation Check 106, optional Mutation Generation 107, and Mutation Insertion 108.

At the control of the Control Files 101, the concurrent simulation system 100 may first go through a Translation step 104 to convert the HDL Code or Computer Program 102 as well as the Testbenches or Test Programs 103 into a Design Database 105. An optional Mutation Check 106, optional Mutation Generation step 107, and Mutation Insertion step 108 may then be performed on the Design Database 105 in any select order. As a result, an equivalent Mutated Circuit Model 109 is generated. Next, a Concurrent Simulation step 110 is performed on the Mutated Circuit Model 109. A Post-Processing step 111 is finally performed to produce a list of Detected Mutations 112 as well as a list of Undetected Mutations 113. All reports and errors are saved in the Report Files 114.

The user-supplied testbenches in 103 are used to verify the correctness of the HDL code given in 102. The user-supplied test programs in 103 are used to verify the correctness of the computer program given in 102. An optional Mutation Check step 106 may be performed only if the Control Files 101 may contain a list of mutations the user wishes to check. If the Control Files 101 does not contain a list of mutations the user wishes to check, then an optional Mutation Generation step 107 may be performed to generate a list of mutations. The list of mutations either supplied by the user directly or generated automatically by the system 100 is then automatically inserted into the Design Database 105 to produce a Mutated Circuit Model 109 for performing a Concurrent Simulation step 110, where simulation of two or more mutations will be performed in a concurrent manner, until all mutations have been processed or the process is terminated when a predetermined criterion is reached.

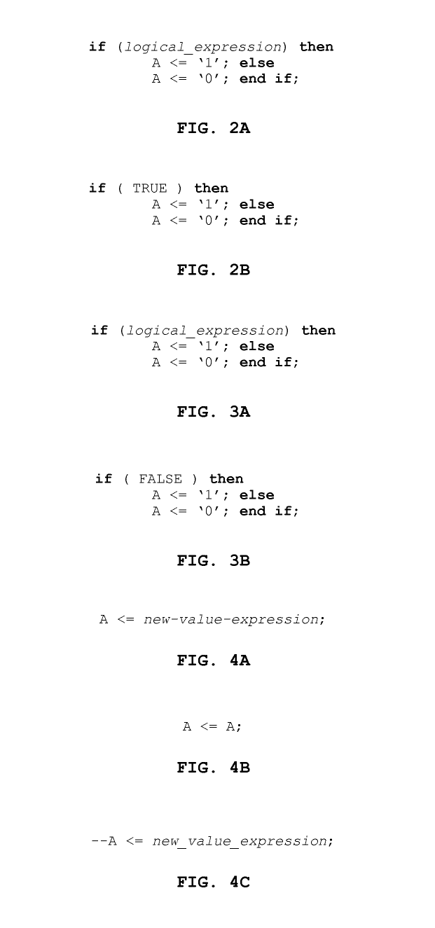

FIGS. 2A and 2B show Stuck-Then faults at a behavioral level, in accordance with the present invention. The Stuck-Then fault represents a failure of the if-then-else construct to ever execute the else statements. In the following example the signal A will always be assigned the value ‘1’ in the presence of a Stuck-Then fault, regardless of the value of logical-expression. For example, FIG. 2A shows an if-then-else construct in VHDL. The Stuck-Then fault is mapped by replacing the logical expression between the if and then keywords with the Boolean value TRUE. The mutated statement is shown in FIG. 2B. This modification insures that the then portion of the if-then statement will always be selected.

FIGS. 3A and 3B show Stuck-Else faults at a behavioral level, in accordance with the present invention. The Stuck-Else fault represents a failure of the if-then-else construct to ever execute the then statements. It is the dual of the Stuck-Then fault and is mapped by replacing the logical expression between the if and then keywords with the Boolean value FALSE. FIG. 3B shows a mutated statement of FIG. 3A, where FIG. 3A is the same as FIG. 2A.

FIGS. 4A, 4B, and 4C show Assignment Control faults at a behavioral level, in accordance with the present invention. The Assignment Control fault represents a failure of the VHDL assignment operator to assign a new value to a signal. In FIG. 4A, the value of the signal A would never be altered if an Assignment Control fault were associated with this statement. The Assignment Control fault is mapped by replacing the expression to the right of the assignment operator, the new-value-expression, with the signal name to the left of the operator, as shown in FIG. 4B, unless the signal is of type out. Signals of type out cannot be read, that is, they cannot appear on the right hand side of an assignment statement or in an expression. Therefore, the assignment control fault for out signals may be mapped by placing the comment symbol (“--”) in front of the assignment statement as shown in FIG. 4C. This has the desired effect of preventing the output signal from being altered by this statement.

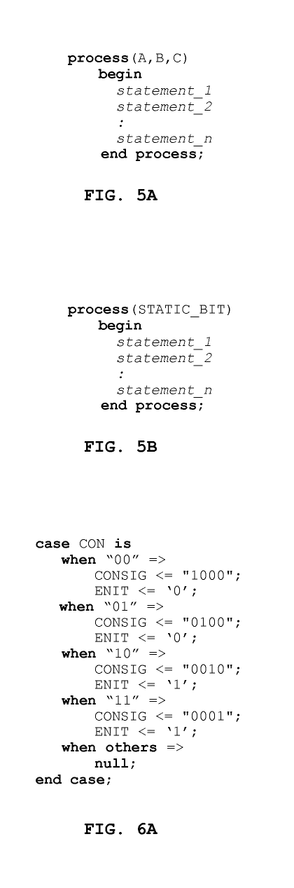

FIGS. 5A and 5B show Dead Process faults at a behavioral level, in accordance with the present invention. The Dead Process fault is mapped by replacing the sensitivity list of the process statement with the reserved signal STATIC-BIT. The signal value of STATIC-BIT never changes. Consequently, if STATIC-BIT is the only signal in the sensitivity list of the process statement, the process will never be triggered. (The sensitivity list is the list of signals which trigger evaluation of the statements within the process( ) construct.) In the preceding example, the sensitivity list is composed of the three signals A, B, and C. The mapping algorithm declares the signal STATIC-BIT in the architecture portion of the circuit model and uses it to replace A, B, and C. The signal name STATIC-BIT may be reserved for mapping Dead Process faults and may not be assigned a value by any activity within the source model. FIG. 5B shows a possible mutation of FIG. 5A.

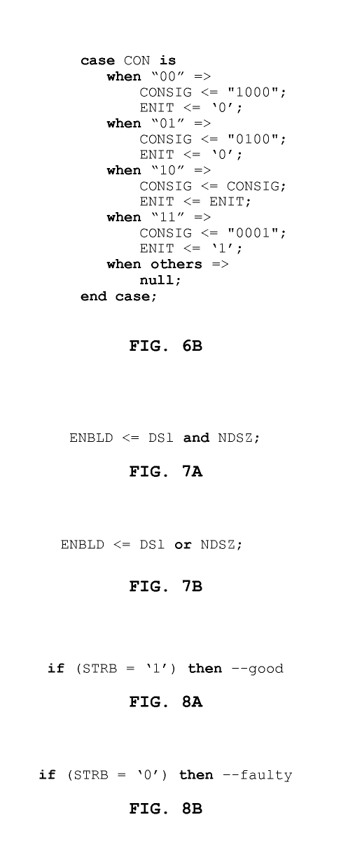

FIGS. 6A and 6B show Dead Clause faults at a behavioral level, in accordance with the present invention. The Dead Clause fault is a failure of the VHDL CASE construct to execute one of the alternative sequences of statements (clauses). For a given case statement for CON which is a bit-vector of length two, none of the statements in the third of the four alternative sequences would be executed in the presence of a dead clause fault when CON is “10”. FIG. 6B shows a possible mutation of FIG. 6A.

FIGS. 7A and 7B show Micro-operation faults at a behavioral level, in accordance with the present invention. A Micro-operation fault is the failure of an operator to perform its intended function. The operator may fail to any other operator in its class. For example, in the assignment statement A<=B XOR C; the XOR may fail to any operator in the logical operator class (and, or, nand, nor, xor). Other operator classes in use are relational (=, 1=, <, <=), and miscellaneous (not). Additionally, the bit-vector functions ADD and SUB are recognized as a class of interchangeable operators even though they are not operators by definition. The ADD and SUB functions are implemented in VHDL as subprograms. The micro-operation fault may be mapped by replacing the target operator with a replacement operator. The replacement operator is expected to be supplied in the fault description. FIG. 7B shows a possible mutation of FIG. 7A.

FIGS. 8A and 8B show Local Stuck-data faults at a behavioral level, in accordance with the present invention. The Local Stuck-data fault is the failure of a signal or variable object to have the correct value. The local stuck-data fault is restricted to the expression into which it is mapped. That is, a signal or object, A, will only be “stuck” in one expression of the circuit model. All other occurrences of A in the model will retain their expected values. FIG. 8B shows a possible mutation of FIG. 8A.

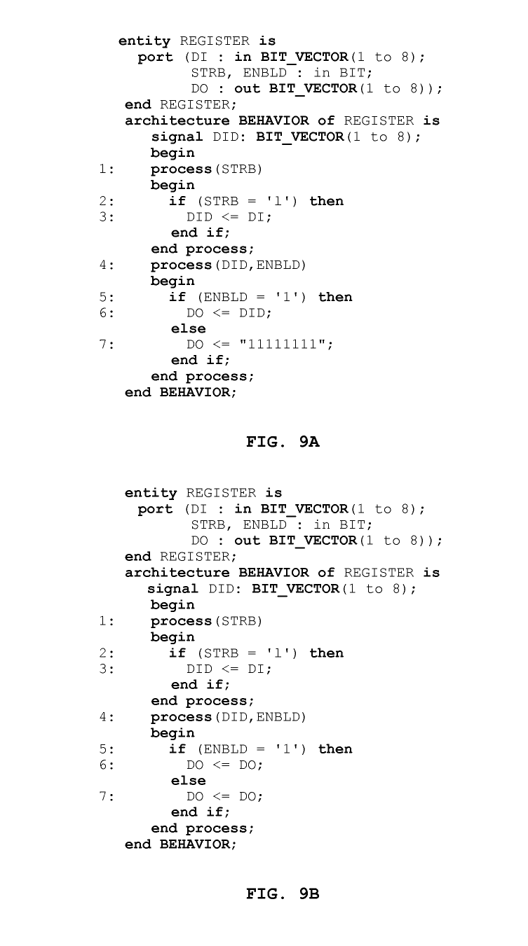

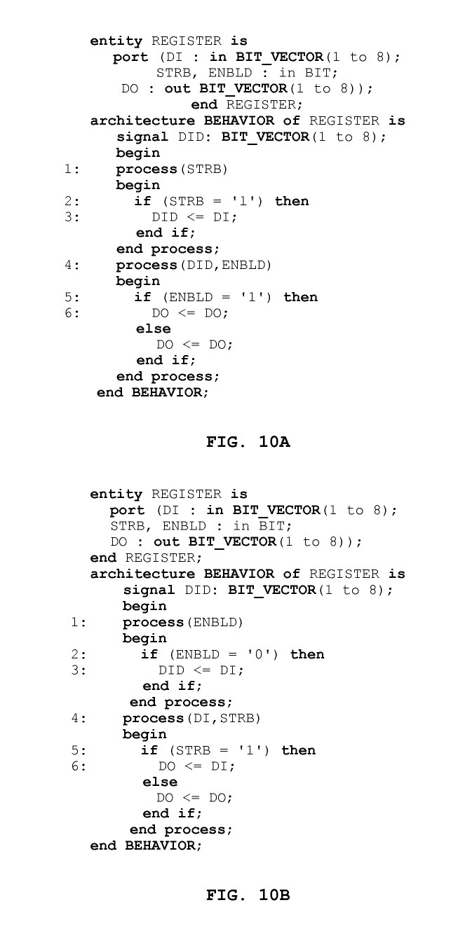

FIGS. 9A and 9B show Global Stuck-data faults at a behavioral level, in accordance with the present invention. The Global Stuck-data fault is the failure of a signal or variable to change value within the circuit model. The global stuck-data fault is similar to the local stuck-data fault except that a global stuck-data fault is not restricted to faulting a single line of the circuit model. The global stuck-data fault will inhibit transitions on a given signal or variable caused by statements within a specified range of the source model. The range over which the signal or variable is stuck is specified in the fault description. The range may vary from a single numbered line of the circuit description to all numbered lines of the circuit description. An example of a physical defect modeled by this fault is a stuck-at fault on a primary circuit input. In FIG. 9A, no statements would be allowed to modify signal DO in the presence of a global stuck-data fault. The global stuck-data fault may be mapped by requesting the Assignment Control fault at all numbered lines within the specified range which contain the target. FIG. 9B shows a possible mutation by modifying the previous statements 6 and 7 in FIG. 9A to read as shown in FIG. 9B.

FIGS. 10A and 10B show module faults at a behavioral level, in accordance with the present invention. A parameter STRB at statement 1 in FIG. 10A is replaced by ENBLD at statement 1 shown in FIG. 10B. Statements 2-6 in FIG. 10B show additional mutations of FIG. 10A. Basically, a module fault in a module may contain one or more other types of design faults inside.

Having thus described and illustrated specific embodiments of the present invention, it is to be understood that the objectives of the invention have been fully achieved. And it will be understood by those skilled in the art that many changes in construction and circuitry, and widely differing embodiments and applications of the invention will suggest themselves without departing from the spirit and scope of the present invention. The disclosures and the description herein are intended to be illustrative and are not in any sense limitation of the invention, more preferably defined in scope by the following claims.

What is claimed is:

1. A method for evaluating the quality of testbenches for an integrated circuit or system simulated by means of a computer, comprising (a) providing a hardware description language (HDL) code which describes the integrated circuit; (b) translating said HDL code together with said testbenches to a design database; (c) inserting a list of mutations in said design database to produce a mutated circuit model; and (d) performing a concurrent simulation on said mutated circuit model using said testbenches, where two or more said mutations are simulated concurrently.

2. The method of claim 1, wherein said step (c) further comprises checking said list of mutations in advance when said list of mutations is supplied to the computer for mutation analysis.

3. The method of claim 1, wherein said step (c) further comprises automatically generating said list of mutations in advance when said list of mutations is not supplied to the computer for mutation analysis.

4. The method of claim 1, wherein said mutation is an artificial bug or a design fault, wherein said design fault further comprises one or more structural faults and behavioral faults.

5. The method of claim 4, wherein said structural fault further comprises a stuck-at fault, a delay fault, a bridging fault, an open fault, or an IDD quiescent (IDDQ) fault.

6. The method of claim 4, wherein said behavioral fault further comprises a Stuck-Then fault, a Stuck-Else fault, an Assignment Control fault, a Dead Process fault, a Dead Clause fault, A Micro-operation fault, a Local Stuck-data fault, a Global Stuck-data fault, or a module fault.

7. The method of claim 1, wherein said step (d) further comprises checking whether said mutation inserted into said mutated circuit model has generated an output value which is different from a reference value, wherein said reference value may be generated internally from said integrated circuit or system or said testbenches, or generated externally from an independent reference system.

8. The method of claim 7, wherein said reference system further comprises a hardware accelerator or an identical design developed independent of said integrated circuit or system to meet the design's specifications.

9. The method of claim 1, wherein said testbench is further used for functional verification or fault simulation of said integrated circuit or system.

10. The method of claim 1, wherein said integrated circuit or system is a computer program, and wherein said testbench is a test program to verify the correctness of said computer program.
